(19) United States
(12) Patent Application Publication
(10) Pub. No.: US 2018/0080305 A1
(43) Pub. Date: Mar. 22, 2018

(54) CONDITION BASED MAINTENANCE PROGRAM BASED ON LIFE-STRESS ACCELERATION MODEL AND TIME-VARYING STRESS MODEL

(71) Applicant: HALLIBURTON ENERGY SERVICES, INC., Houston, TX (US)

(72) Inventors: Curtis Jacks, Katy, TX (US); Keeley Burke, Stonehouse (GB); Wanying Chen, Singapore (SG)

(73) Assignee: HALLIBURTON ENERGY SERVICES, INC., Houston, TX (US)

(21) Appl. No.: 15/558,959

(22) PCT Filed: May 18, 2015
(86) PCT No.: PCT/US15/31414

§ 371 Date: Sep. 15, 2017

(51) Int. Cl. E21B 41/00; E21B 47/00; G06F 17/50

(52) U.S. Cl. CPC E21B 41/0092; G06F 2217/16; G06F 17/5009; E21B 47/00

(57) ABSTRACT

Methods and system for implementing Condition Based Maintenance (CBM) of downhole systems and equipment, including drilling tools, wireline tools and production tools is presented in this disclosure. The presented CBM-based approach combines the use of a tool life distribution with a life-stress acceleration model and a time-varying stress model to model failure times of a tool. One or more failure parameters related to operation of the tool during the operational run can be calculated based on a life measure of the tool determined for each step in the series of steps of the operational run, a time duration of each step, and a life duration of the tool at reference levels of stress variables. Maintenance of the tool can be performed based on the calculated failure parameters.

### TECHNICAL FIELD

The present disclosure generally relates to maintenance of downhole tools and, more particularly, to condition based maintenance programs for downhole tools based on a life-stress acceleration model and a time-varying stress model.

### BACKGROUND

Oil and gas wells produce oil, gas and/or byproducts from subterranean petroleum reservoirs. Various systems are utilized to drill and then extract these hydrocarbons from the wells. Since the environmental conditions within such wells are typically comparatively harsh, with high temperatures, high pressures and corrosive fluids, it is important to be able to accurate predict the effects of the environment on these systems, particularly when the systems may be subject to repetitive usage, in order to identify the appropriate maintenance schedule for a particular system before the system experiences any operational degradation. Condition Based Maintenance (CBM) methodologies are utilized to evaluate systems in light of the foregoing. Life-stress acceleration models are at the heart of Condition Based Maintenance (CBM) algorithm calculation. The life-stress acceleration models are well-established in the area of Accelerated Life Testing (ALT) and are able to relate life of systems, such as downhole tools or components thereof, consumed at different stress levels. ALT involves testing of components at very high stress levels and at a time-constant stress. However, it may not be practical to test downhole systems at those very higher stress levels since stress levels at downhole conditions are already very harsh. Furthermore, additional time-consuming and expensive lab tests are necessary for ALT, which may not fit within the parameters of a particular hydrocarbon drilling and recovery operation.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a workflow for obtaining a Condition Based Maintenance (CBM) algorithm, according to certain embodiments of the present disclosure.

FIG. 2 is a block diagram illustrating an overview of working principles of the CBM algorithm, according to certain embodiments of the present disclosure.

FIG. 3 is a flow chart of operation of the CBM method, according to certain embodiments of the present disclosure.

FIG. 4 is a flow chart of a method for operating the CBM based on a life-stress acceleration model and a time-varying stress model, according to certain embodiments of the present disclosure.

FIG. 5 is a block diagram of an exemplary computer system in which embodiments of the present disclosure may be implemented.

FIG. 6 is a diagram of a land-based drilling system in which the CBM methodology may be used, according to certain embodiments of the present disclosure.

FIG. 7 is a diagram of a marine production system in which the CBM methodology may be used, according to certain embodiments of the present disclosure.

### DETAILED DESCRIPTION

Embodiments of the present disclosure relate to Condition Based Maintenance (CBM) program based on life-stress acceleration models for downhole systems and equipment, including drilling tools, wireline tools and production tools. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It would also be apparent to one skilled in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

The foregoing disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper,” “uphole,” “downhole,” “upstream,” “downstream,” and the like, may be used herein for ease of description to describe one element or feature's relationship to another element(s) or feature(s) as illustrated in the figures. The spatially relative terms are intended to encompass different orientations of the apparatus in use or operation in addition to the orientation depicted in the figures. For example, if the apparatus in the figures is turned over, elements described as being “below” or “beneath” other elements or features would then be oriented “above” the other elements or features. Thus, the exemplary term “below” may encompass both an orientation of above and below. The apparatus may be otherwise oriented (rotated 90 degrees or at other orientations) and the spatially relative descriptors used herein may likewise be interpreted accordingly.

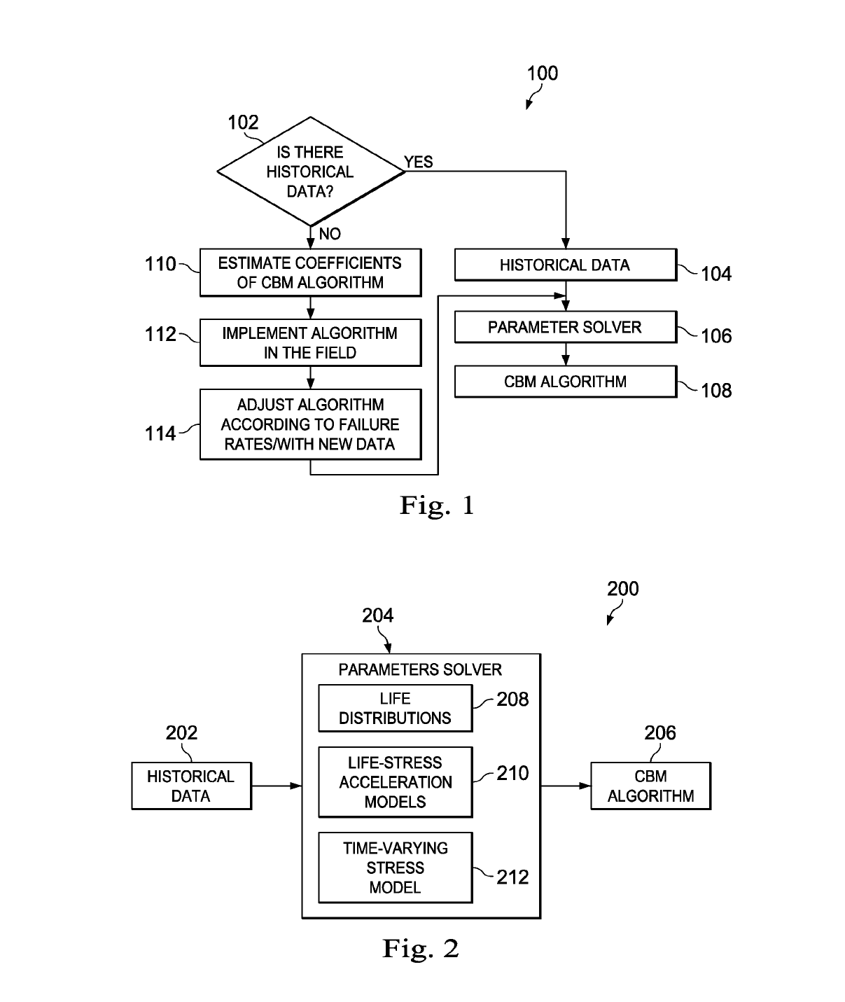

Illustrative embodiments and related methodologies of the present disclosure are described below in reference to FIGS. 1-7 as they might be employed, for example, in a computer system for performing Condition Based Maintenance (CBM) for oilfield systems and equipment based on life-stress acceleration models. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

The present disclosure establishes a methodology to implement Condition Based Maintenance (CBM) program for oilfield systems and equipment, including Logging While Drilling (LWD) tools and Measurement While Drilling (MWD) tools. The methodology presented in this disclosure can be also extended to wireline tools, production tools and other systems and equipment utilized in hydrocarbon drilling and production. In accordance with certain embodiments of the present disclosure, the CBM program may create a more effective maintenance system based on direct utilization of field data so that the appropriate maintenance can be performed at the appropriate time, thereby optimizing a frequency of performing maintenance.

Implementation of an automated CBM schedule for specific equipment may be of great importance for complying with customers' requirements. For example, customers may desire that down hole tools should be subjected to a Preventive Maintenance (PM) program, wherein the maintenance schedule can be triggered depending on the environmental conditions the tools are subjected to.

In accordance with certain embodiments of the present disclosure, the working product of the CBM program may be an algorithm or a series of algorithms that calculate an equivalent number of hours (e.g., at reference stress level) that a particular tool has undergone based on environmental conditions that the tool is subjected to. Having calculated the equivalent run hours of the tool, an end of life of the tool may be predicted and maintenance to be performed can be scheduled before the tool reaches its end of life. The present disclosure describes the principles and methodology behind obtaining the CBM-based algorithm(s).

The approach presented in this disclosure utilizes historical data combined with a time-varying stress model to account for varying stress levels observed in historical field data. For certain embodiments where historical data are not available, initial coefficients of the CBM algorithm may be estimated based on, for example, domain knowledge, manufacturer's data, and/or comparison with similar product(s). Following implementation of the CBM system, the coefficients of the CBM algorithm may be adjusted based on actual field failure rates.

FIG. 1 shows a workflow 100 for obtaining a CBM algorithm (or a series of CBM algorithms), according to certain embodiments of the present disclosure. The approach presented herein can utilize historical data, so that additional lab tests may be avoided. As illustrated in FIG. 1, at a decision step 102, it may be determined if historical data are available. In an embodiment of the present disclosure, if the historical data are available, then, for example, historical data 104 may be fed into a parameter solver 106 to determine parameters for a CBM algorithm 108. Alternatively, in another embodiment, if historical data are not available (e.g., which may be determined at the decision step 102), initial coefficients of the CBM algorithm may be estimated, at a step 110, using, for example, domain knowledge, manufacturer's data, and/or comparison with similar products. Based on the initial coefficients estimated at the step 110, a CBM-based algorithm may be implemented in a field, at a step 112. As new data are being collected during the field operation, the CBM-based algorithm may be adjusted according to failure rates, at a step 114. Furthermore, as illustrated in FIG. 1, the collected new data may be fed into the parameter solver 106 to update parameters (coefficients) for the CBM algorithm 108.

FIG. 2 shows an overview 200 of working principles of the CBM algorithm, according to certain embodiments of the present disclosure. The approach presented in this disclosure combines the use of a life distribution with a life-stress acceleration model and a time-varying stress model to model failure of a tool (component). As illustrated in FIG. 2, historical data 202 may be fed into a parameter solver 204 to determine parameters (coefficients) for a CBM algorithm 206. The parameter solver 204 may combine life distributions 208 with life-stress acceleration models 210 and a time-varying stress model 212 for modeling tool failure and calculate parameters (coefficients) for the CBM algorithm 206. For some embodiments of the present disclosure, the life distributions 208 may refer to statistical models that describe probability of (tool) failure with time. The life-stress acceleration models 210 may define the relationship of life of a component at different stress levels. For some embodiments, the time-varying stress model 212 may be incorporated into the parameter solver 204 to account for varying stress levels during model building and usage of the tool.

For certain embodiments of the present disclosure, the approach presented herein for obtaining parameters (coefficients) for the CBM algorithm may utilize historical data (e.g., the historical data 202), and therefore additional time-consuming and expensive lab tests may be avoided. For some embodiments, in the case when historical data are not available, initial life distribution and life-stress acceleration models (e.g., the models 208 and 210) may be estimated based on, for example, domain knowledge, manufacturer's data and/or comparison with similar products. As data are being collected during field operation, the models 208 and 210 may be updated and adjusted to provide improved results.

Life distribution models utilized in certain embodiments of the present disclosure can describe how a tool population fails over time. There are several distributions that have been defined mathematically. Some of the more common distributions include Exponential distribution, Weibull distribution and Lognormal distribution. For example, the Weibull distribution can be used in reliability and life data analysis due to its versatility. By varying values of parameters, the Weibull distribution can be utilized to model a variety of life behaviors. Hence, the Weibull distribution represents an exemplary distribution utilized in this disclosure. The probability density function (PDF) of the Weibull distribution can be defined as:

$$f ( t ) = \frac{β}{η} {( \frac{t}{η} )}^{β - 1} {e}^{{( \frac{t}{η} )}^{β}} , \qquad ( 1 )$$

where t is an elapsed time, β is a shape parameter, and η is a scale parameter that may represent a characteristic life, i.e., a time at which 63.2% of the tool population would fail.

For certain embodiments of the present disclosure, generating the CBM algorithms may be based on life-stress acceleration models, which relate life of a component (tool) to a stress level that the component has undergone. The concept is developed in the area of Accelerated Life Testing (ALT), where components are tested to failure at much higher stress condition(s) and transformed to normal (reference) usage condition(s) using life-stress acceleration models. There are many well-established life-stress acceleration models that have been developed to quantify time acceleration of life metrics versus various types of stressors (stress variables), such as temperature, vibration, humidity, voltage, pressure, and so on. The life-stress acceleration models can be used for scaling units of time at different levels of stress into a time at a common reference stress. Some of the life-stress acceleration models are based on physics, while others are derived empirically.

In certain embodiments of the present disclosure, the General Log Linear (GLL) model can be employed as the life-stress acceleration model. The GLL-based life-stress acceleration model represents a versatile model that is able to combine mathematically different life stress acceleration models into a single model. The generic formulation of the GLL model may be defined as:

η=L(X̅)=e^{C}^{ₒ}^{+Σ}^{ᵢ₌₁}^{ⁿ}^{C}^{ᵢ}^{X}^{ᵢ}, (2)

where L(X̅) is a life measure (e.g., a number of hours/days/years, etc.) or the characteristic life η, Xᵢ (i=1, . . . , n) are stressors or stress variables (e.g., temperature, vibration, humidity, voltage, pressure, etc.), and Cᵢ (i=1, . . . , n) are model parameters (coefficients) determined based on historical data or being estimated, wherein each model parameter Cᵢ is associated with a corresponding stressor Xᵢ.

In one or more embodiments, it can be expected that more stress would be accumulated when two (or more) stress variables (stressors) are at high levels at the same time compared to the case when these two (or more) stress variables occur separately. In this case, the generic formulation of the GLL model for the life measure given by equation (2) may include terms modeling interaction between these two (or more) stress variables. For example, Xᵢ and its corresponding model parameter Cᵢ may be related to an interaction term modeling interaction between two or more individual stress variables. Hence, the value of n may correspond to a total number of stressors (stress variables) including one or more interaction terms (variables). The combined Weibull-GLL life stress acceleration model may be obtained by combining equations (1) and (2) as:

$$f ( t ) = \frac{β}{η} {( \frac{t}{η} )}^{β - 1} {e}^{{( \frac{t}{η} )}^{β}} = \frac{β}{{e}^{{C}_{o} + {\sum }_{i = 1}^{n} {C}_{i} {X}_{i}}} {( \frac{t}{{e}^{{C}_{o} + {\sum }_{i = 1}^{n} {C}_{i} {X}_{i}}} )}^{β - 1} {e}^{{( \frac{t}{{e}^{{C}_{o} + {\sum }_{i = 1}^{n} {C}_{i} {X}_{i}}} )}^{β}} . \qquad ( 3 )$$

The combined Weibull-GLL life stress acceleration model defined by equation (3) may be applicable for constant stress levels. As historical data and current usage data are typically time-varying, the combined Weibull-GLL life stress acceleration model may be combined with a time varying stress model.

For certain embodiments of the present disclosure, the time-varying stress model may be built with the following considerations. At any time, the remaining life of a component (tool) may depend on a stress that has been accumulated so far, and not on how the stress was accumulated. During an operation step of a component (tool), the component may fail according to the failure distribution of the stress at the current step, but with a starting age corresponding to the accumulated stress at the beginning of the step. At the end of an operation step, the failure distribution at the current stress level may be equivalent to the failure distribution at the start of the next step with the next stress level.

For some embodiments of the present disclosure, at the end of step 1, the probability of a component (tool) having failed at the current stress level may be equal to the probability of a failure at the stress level of step 2. Therefore, the equivalent start time of step 2, ε₁, may be found such that:

F(t₁,X₁)=F(ε₁,X₂). (4)

### Hence:

$${ɛ}_{1} = {t}_{1} \frac{η ( {X}_{2} )}{η ( {X}_{1} )} = {t}_{1} * exp \{ {\sum }_{i = 1}^{n} {C}_{i} [ {x}_{i} ( 2 ) - {x}_{i} ( 1 ) ] \} . \qquad ( 5 )$$

For some embodiments of the present disclosure, the failure distribution during step 2 may be modeled as:

$${F}_{2} ( t , {X}_{2} ) = F ( t - {t}_{1} + {ɛ}_{1} , {X}_{2} ) = 1 - {e}^{- {( \frac{t - {t}_{1} + {ɛ}_{1}}{η ( {X}_{2} )} )}^{β}} . \qquad ( 6 )$$

After generalization to a step j, the equivalent start time of step j, εⱼ₋₁, may be obtained as:

$$\begin{matrix}{ɛ}_{j - 1} = ( {t}_{j - 1} - {t}_{j - 2} + {ɛ}_{j - 2} ) \frac{η ( {X}_{j} )}{η ( {X}_{j - 1} )} = \\ = ( {t}_{j - 1} - {t}_{j - 2} + {ɛ}_{j - 2} ) * exp \{ {\sum }_{i = 1}^{n} {C}_{i} [ {x}_{i} ( j ) - {x}_{i} ( j - 1 ) ] \} .\end{matrix} \qquad ( 7 )$$

For some embodiments of the present disclosure, the failure distribution during the step j may be then modeled as:

$${F}_{j} ( t , {X}_{j} ) = F ( t - {t}_{j - 1} + {ɛ}_{j - 1} , {X}_{j} ) = 1 - {e}^{- {( \frac{t - {t}_{j - 1} + {ɛ}_{j - 1}}{η ( {X}_{j} )} )}^{β}} , \qquad ( 8 )$$

where:

η(Xⱼ)=e^{C}^{ₒ}^{+Σ}^{ᵢ₌₁}^{ⁿ}^{C}^{ᵢ}^{X}^{ᵢ}, (9)

and Fⱼ(t, Xⱼ) represents the probability of failure at a time instant t during the step j.

In accordance with certain embodiments of the present disclosure, for each stress to be included, a reference stress level may be defined, collectively for all stress variables as X_{ref}. The reference stress level may represent a level below which a change to the stress does not affect the life of the tool. Then, the value of η(X_{ref}) can be defined as the life of the tool at the reference stress levels.

For some embodiments of the present disclosure, a proportion of tool life consumed over a single operational run with m steps may be calculated, using Miners rule, as:

$$C = {\sum }_{j = 1}^{m} \frac{{t}_{j} - {t}_{j - 1}}{η ( {X}_{j} )} . \qquad ( 10 )$$

Then, the equivalent hours consumed at the reference stress for the single operational run with m steps may be obtained as:

$$Equivalent hours = η ( {X}_{ref} ) {\sum }_{j = 1}^{m} \frac{{t}_{j} - {t}_{j - 1}}{η ( {X}_{j} )} . \qquad ( 11 )$$

Once the equivalent hours consumed for the current operational run are obtained, one or more failure parameters such as a Remaining Useful Life (RUL) parameter may be calculated as:

RUL=η(X_{ref})−Equivalent hours. (12)

For certain embodiments of the present disclosure, field operators may use the RUL parameter obtained by equation (12) to determine if the tool can still be used, or if the tool should be sent for maintenance.

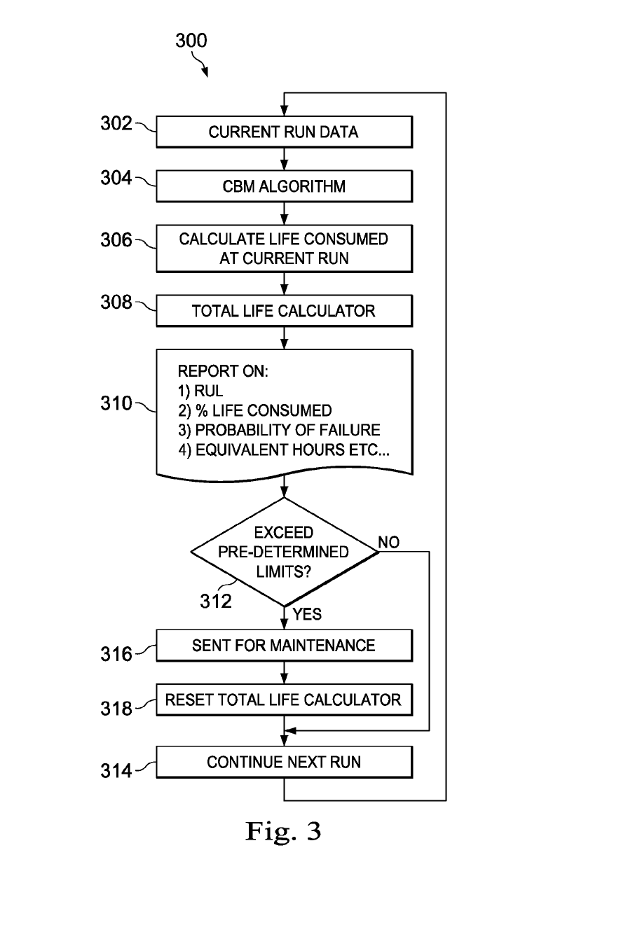

FIG. 3 shows a flow chart 300 of operation of Condition Based Maintenance (CBM), according to certain embodiments of the present disclosure. In some embodiments, as discussed, historical data may be fed into the parameter solver to calculate parameters of life equation for each tool, which may form the CBM algorithm. Once a tool is sent for mission, new run data 302 may be fed into a CBM algorithm 304 to calculate the tool life consumed during the current run (e.g., performed during a step 306). The tool life being consumed during the current run may be added to a total life calculator 308 to calculate, at a step 310, failure parameters such as RUL, percentage of life consumed, probability of failure, equivalent hours, and so on. These parameters may be compared, at a decision step 312, with one or more pre-determined threshold values to decide if the tool should be sent for maintenance. In an embodiment of the present disclosure, if the one or more pre-determined threshold values are not exceeded, maintenance may not be performed and the tool may be sent and continued for a next operational run, at a step 314. If the tool is sent for another operational run, equivalent hours obtained from the next operational run may be added to the equivalent hours already accumulated. In another embodiment, if the one or more pre-determined threshold values are exceeded, the tool may be sent for maintenance at a step 316, and the Total Life Calculator may be reset at a step 318 before the next operational run.

In one or more embodiments of the present disclosure, rather than performing maintenance in response to determination of these failure parameters, a mission for the tool may be selected that will minimize the need for maintenance at the time the calculations are determined. For example, a tool may be selected for a task based on the failure parameters so that the failure parameters, even when altered by operation of the tool during the new task, will not exceed the pre-determined threshold. In other words, the particular task or mission for which a tool may be deployed may be selected based on the calculations in order to minimize the time the tool is “down” for maintenance.

For some embodiments of the present disclosure, when historical data are available, the parameters (coefficients) of the GLL model defined by equation (2), C₀, C₁, . . . , Cₙ, may be obtained using, for example, maximum likelihood estimation. Data related to the failure and/or suspension times of a number of tools may be utilized, as well as the stress levels throughout the life of each tool. The failure and suspension times may be recorded, for example, as F failed samples with failure times f₁, f₂, . . . , f_{F}, and S suspended samples with suspension times f_{F|1}, . . . , f_{F|S}, respectively.

For certain embodiments of the present disclosure, stress data may be collected in a matrix form, where x_{i,k}(j) represents a stress level of a variable i, in a sample k at a time step j. Data may be captured in discrete time steps of length L, where fᵢ=mᵢ·L and mᵢ is a number of time steps associated with the stress variable i in an operational run. In one or more embodiments of the present disclosure, L may be constant and small enough so that only the time at the end of a step is of interest, and not the time in between steps.

For certain embodiments of the present disclosure, for the time varying stress model, the amount of stress accumulated over time may be obtained as:

$$I ( t , {x}_{\cdot , k} , C ) = {\sum }_{j = 1}^{j = t / L} \frac{L}{η ( {x}_{\cdot , k} ( j ) )} . \qquad ( 13 )$$

Then, the probability density function (PDF) of the failure distribution may become:

$$f ( t , {x}_{\cdot , k} \vert C , β ) = \frac{β}{η ( {x}_{\cdot , k} ( t ) )} {( I ( t , {x}_{\cdot , k} ( t ) ) )}^{β - 1} exp \{ - {( I ( t , {x}_{\cdot , k} ( t ) ) )}^{β} \} . \qquad ( 14 )$$

The log likelihood function of the PDF may be then given as:

$$\begin{matrix}Λ = {\sum }_{j = 1}^{F} ln [ f ( {f}_{k} , {x}_{\cdot , k} \vert C , β ) ] + {\sum }_{j = F + 1}^{F + S} ln [ 1 - F ( {f}_{k} , {x}_{\cdot , j} \vert C , β ) ] = \\ = {\sum }_{j = 1}^{F} \{ ln [ \frac{β}{η ( {x}_{\cdot , k} ( {f}_{k} ) , C )} {( I ( {f}_{k} , {x}_{\cdot , k} , C ) )}^{β - 1} ] - {( I ( {f}_{k} , {x}_{\cdot , k} , C ) )}^{β} \} + \\ {\sum }_{j = F + 1}^{F + S} - {( I ( {f}_{k} , {x}_{\cdot , k} , C ) )}^{β} .\end{matrix} \qquad ( 15 )$$

For certain embodiments of the present disclosure, the maximum likelihood estimates of the parameters (coefficients) C of the GLL model may be the values that maximize the log likelihood function defined by equation (15).

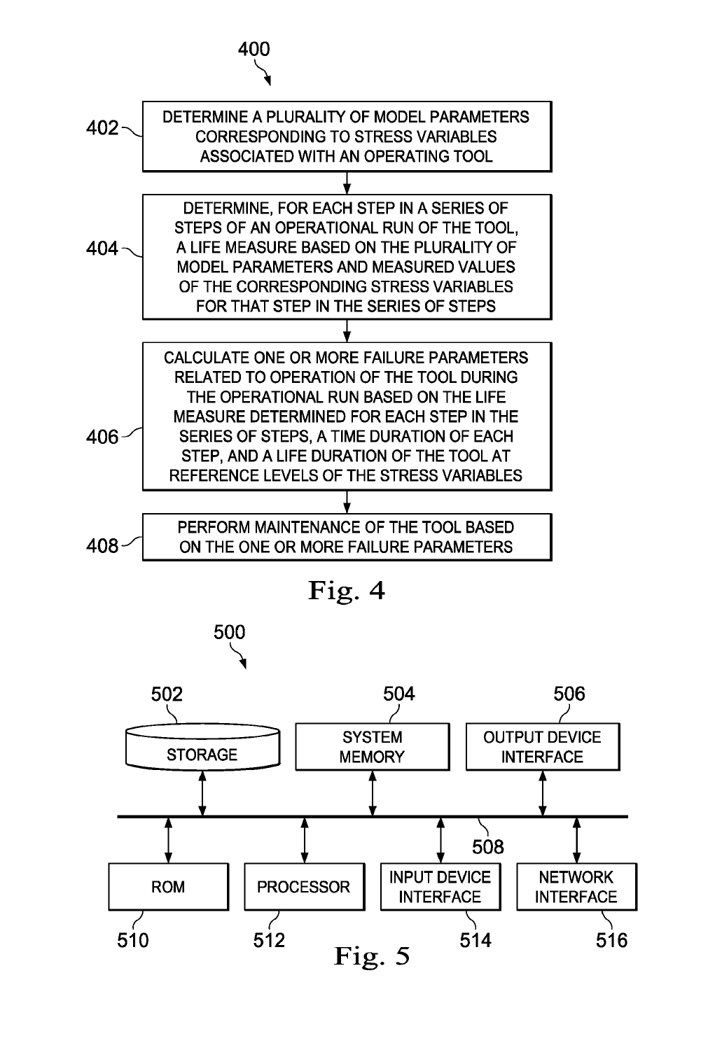

Discussion of an illustrative method of the present disclosure will now be made with reference to FIG. 4, which is a flow chart 400 of a method for performing the CBM algorithm for an operating tool based on the life-stress acceleration model and the time-varying stress model, according to certain embodiments of the present disclosure. The method begins at 402 by determining a plurality of model parameters (e.g., the model parameters C of the GLL model) corresponding to stress variables (e.g., the variables xᵢ, i=1, . . . , n) associated with the tool. At 404, for each step in a series of steps of an operational run of the tool, a life measure (e.g., the characteristic life value η(Xⱼ) according to equation (9), j=1, . . . , m) may be determined based on the plurality of model parameters (e.g., the model parameters Cᵢ, i=1, . . . , n) and measured values of the corresponding stress variables for that step in the series of steps (e.g., the values xᵢ(j), i=1, . . . , n; j=1, . . . , m). At 406, one or more failure parameters (e.g., RUL, percentage of tool life consumed, a probability of failure, equivalent hours) related to operation of the tool during the operational run may be calculated based on the life measure for each step in the series of steps (e.g., based on the values η(Xⱼ), j=1, . . . , m), a time duration of each step (e.g., values tⱼ−tⱼ₋₁, j=1, . . . , m), and a life duration of the tool at reference levels of the stress variables (e.g., the value η(X_{ref})). At 408, maintenance of the tool may be performed based on the one or more failure parameters.

FIG. 5 is a block diagram of an exemplary computer system 500 in which embodiments of the present disclosure may be implemented adapted for implementing a CBM program based on life-stress acceleration models for downhole systems and equipment. For example, the steps of workflows 100, 200 and 300 from FIGS. 1-3 and the steps of method 400 of FIG. 4, as described above, may be implemented using the system 500. The system 500 can be a computer, phone, personal digital assistant (PDA), or any other type of electronic device. Such an electronic device includes various types of computer readable media and interfaces for various other types of computer readable media. As shown in FIG. 5, the system 500 includes a permanent storage device 502, a system memory 504, an output device interface 506, a system communications bus 508, a read-only memory (ROM) 510, processing unit(s) 512, an input device interface 514, and a network interface 516.

The bus 508 collectively represents all system, peripheral, and chipset buses that communicatively connect the numerous internal devices of the system 500. For instance, the bus 508 communicatively connects the processing unit(s) 512 with the ROM 510, the system memory 504, and the permanent storage device 502.

From these various memory units, the processing unit(s) 512 retrieves instructions to execute and data to process in order to execute the processes of the subject disclosure. The processing unit(s) can be a single processor or a multi-core processor in different implementations.

The ROM 510 stores static data and instructions that are needed by the processing unit(s) 512 and other modules of the system 500. The permanent storage device 502, on the other hand, is a read-and-write memory device. This device is a non-volatile memory unit that stores instructions and data even when the system 500 is off. Some implementations of the subject disclosure use a mass-storage device (such as a magnetic or optical disk and its corresponding disk drive) as the permanent storage device 502.

Other implementations use a removable storage device (such as a floppy disk, flash drive, and its corresponding disk drive) as the permanent storage device 502. Like the permanent storage device 502, the system memory 504 is a read-and-write memory device. However, unlike the storage device 502, the system memory 504 is a volatile read-and-write memory, such a random access memory. The system memory 504 stores some of the instructions and data that the processor needs at runtime. In some implementations, the processes of the subject disclosure are stored in the system memory 504, the permanent storage device 502, and/or the ROM 510. For example, the various memory units include instructions for computer aided pipe string design based on existing string designs in accordance with some implementations. From these various memory units, the processing unit(s) 512 retrieves instructions to execute and data to process in order to execute the processes of some implementations.

The bus 508 also connects to the input and output device interfaces 514 and 506. The input device interface 514 enables the user to communicate information and select commands to the system 500. Input devices used with the input device interface 514 include, for example, alphanumeric, QWERTY, or T9 keyboards, microphones, and pointing devices (also called “cursor control devices”). The output device interfaces 506 enables, for example, the display of images generated by the system 500. Output devices used with the output device interface 506 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 5, the bus 508 also couples the system 500 to a public or private network (not shown) or combination of networks through a network interface 516. Such a network may include, for example, a local area network (“LAN”), such as an Intranet, or a wide area network (“WAN”), such as the Internet. Any or all components of the system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of method 400 of FIG. 4, as described above, may be implemented using the system 500 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

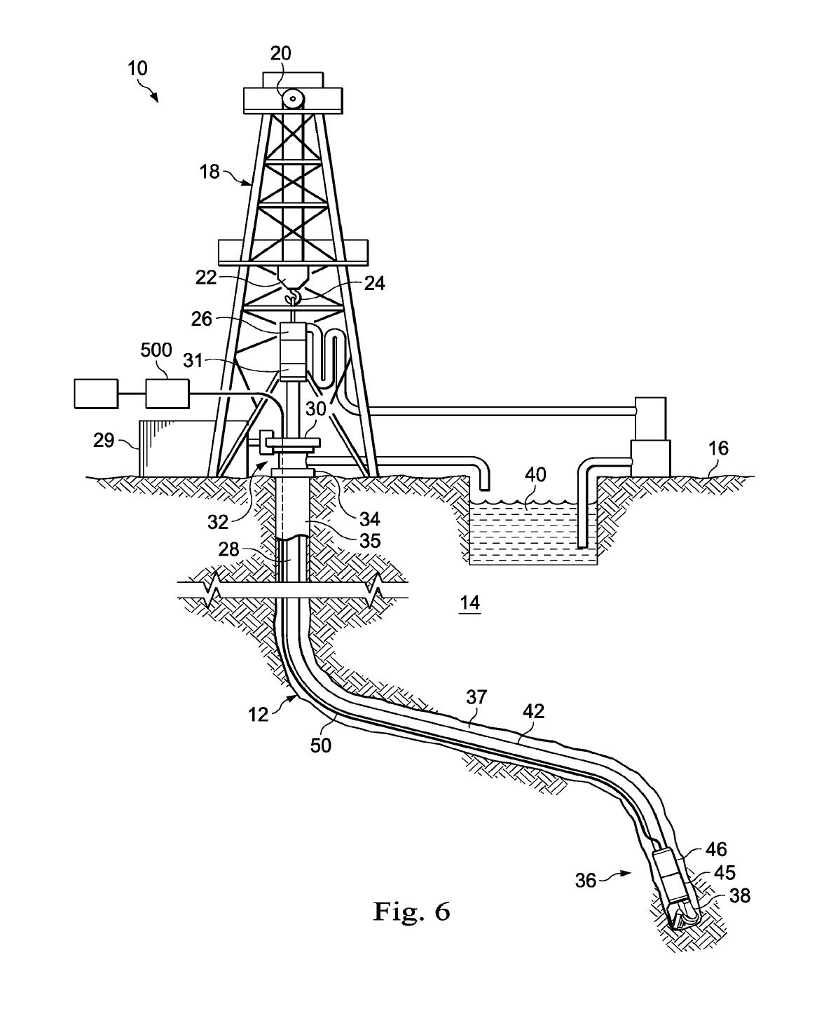

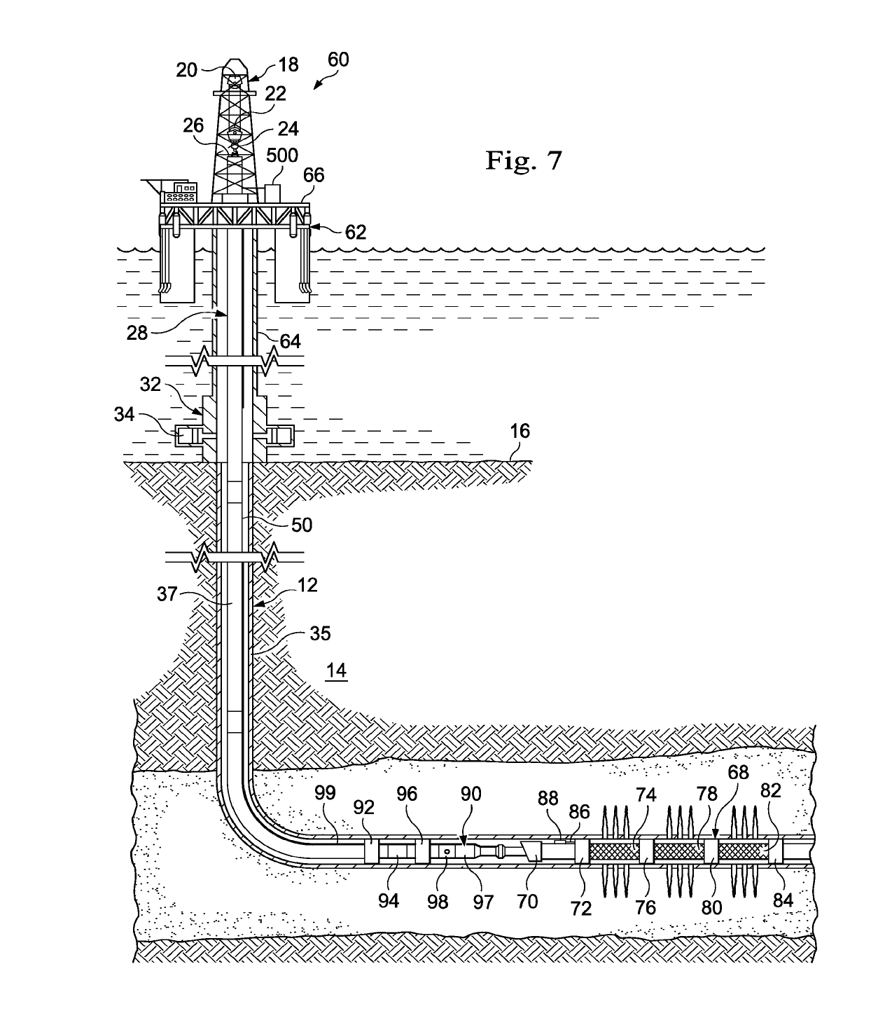

As described above, embodiments of the present disclosure are particularly useful for condition based maintenance of various drilling and wireline tools (components) used in drilling and production systems such as those illustrated in FIGS. 6 and 7.

FIG. 6 is an elevation view in partial cross-section of a drilling and production system 10 utilized to recover hydrocarbons from a wellbore 12 extending through various earth strata in an oil and gas formation 14 located below the earth's surface 16. Drilling and production system 10 may include a drilling rig 18, such as the land drilling rig shown in FIG. 6. Drilling rig 18 may include a hoisting apparatus 20, a travel block 22, a hook 24 and a swivel 26 or similar mechanisms for raising and lowering various conveyance vehicles 28, such as pipe string, coiled tubing, wireline, slickline, and the like. In the illustration, conveyance vehicle 28 is a substantially tubular, axially extending drill string. Likewise, drilling rig 12 may include rotary table 30, rotary drive motor 29, and other equipment associated with rotation and/or translation of tubing string 28 within a wellbore 12. For some applications, drilling rig 18 may also include a top drive unit 31. Although drilling system 10 is illustrated as being a land-based system, drilling system 10 may be deployed on offshore platforms, semi-submersibles, drill ships, and the like.

Drilling rig 18 may be located proximate to or spaced apart from a well head 32, such as in the case of an offshore arrangement (not shown). One or more pressure control devices 34, such as blowout preventers and other equipment associated with drilling or producing a wellbore may also be provided at well head 32.

Wellbore 12 may include a casing string 35 cemented therein. Annulus 37 is formed between the exterior of tubing string 28 and the inside wall of wellbore 12 or casing string 35, as the case may be.

The lower end of drill string 28 may include bottom hole assembly 36, which may carry at a distal end a rotary drill bit 38. Drilling fluid 40 may be pumped to the upper end of drill string 28 and flow through the longitudinal interior 42 of drill string 28, through bottom hole assembly 36, and exit from nozzles formed in rotary drill bit 38. At bottom end 44 of wellbore 12, drilling fluid 40 may mix with formation cuttings, formation fluids and other downhole fluids and debris. The drilling fluid mixture may then flow upwardly through annulus 37 to return formation cuttings and other downhole debris to the surface 16.

Bottom hole assembly 36 may include a downhole mud motor 45. Bottom hole assembly 36 and/or drill string 28 may also include various other tools 46 including MWD, LWD instruments, detectors, circuits, or other equipment that provide information about wellbore 12 and/or formation 14, such as logging or measurement data from wellbore 12. Measurement data and other information may be communicated using electrical signals, acoustic signals or other telemetry that can be converted to electrical signals at the well surface to, among other things, monitor the performance of drilling string 28, bottom hole assembly 36, and associated rotary drill bit 32, as well as monitor the conditions of the environment to which the bottom hole assembly 36 is subjected.

Shown deployed in association with drilling and production system 10 is computer system 500 illustrated in FIG. 5 adapted for implementing a CBM program based on life-stress acceleration models as described herein. For example, during a drilling procedure, the environment in which drill bit 38 is operated, and additionally or alternatively, the actual condition of drill bit 38 may be monitored and utilized by computer system 500 as described above to determine a maintenance program for drill bit 38. Thus, drill bit 38 may be deployed and utilized in wellbore 12 for drilling operations. The conditions under which it is operated are measured. Prior to re-deploying drill bit 38, the CBM program may be utilized to determine whether it is necessary to subject drill bit 38 to maintenance prior to additional deployments.

Likewise, FIG. 7 is an elevation view in partial cross-section of a drilling and production system 60 utilized to recover hydrocarbons from a wellbore 12 extending through various earth strata in an oil and gas formation 14 located below the earth's surface 16. Drilling and production system 60 may include a drilling rig 18 which may be mounted on an oil or gas platform 62, such as illustrated in the offshore platform shown in FIG. 7. Drilling rig 18 may include a hoisting apparatus 20, a travel block 22, a hook 24 and a swivel 26 or similar mechanisms for raising and lowering various conveyance vehicles 28, such as pipe string, coiled tubing, wireline, slickline, and the like. In the illustration, conveyance vehicle 28 is a substantially tubular, axially extending production string. Although system 10 is illustrated as being a marine-based system, system 10 may be deployed on land. For offshore operations, whether drilling or production, subsea conduit 64 extends from deck 66 of platform 62 to a subsea wellhead installation 32, including pressure control devices 34. Tubing string 28 extends down from drilling rig 18, through subsea conduit 64 and into wellbore 12.

Drilling rig 18 may be located proximate to or spaced apart from a well head 32, such as in the case of an offshore arrangement. One or more pressure control devices 34, such as blowout preventers and other equipment associated with drilling or producing a wellbore may also be provided at well head 32.

Wellbore 12 may include a casing string 35 cemented therein. Annulus 37 is formed between the exterior of tubing string 28 and the inside wall of wellbore 12 or casing string 35, as the case may be.

Disposed in a substantially horizontal portion of wellbore 12 is a lower completion assembly 68 that includes various tools such as an orientation and alignment subassembly 70, a packer 72, a sand control screen assembly 74, a packer 76, a sand control screen assembly 78, a packer 80, a sand control screen assembly 82 and a packer 84.

Extending downhole from lower completion assembly 68 is one or more communication cables 86, such as a sensor or electric cable, that passes through packers 72, 76 and 80 and is operably associated with one or more electrical devices 88 associated with lower completion assembly 68, such as sensors position adjacent sand control screen assemblies 74, 78, 82 or at the sand face of formation 14, or downhole controllers or actuators used to operate downhole tools or fluid flow control devices. Cable 86 may operate as communication media, to transmit power, or data and the like between lower completion assembly 68 and an upper completion assembly 90.

In this regard, disposed in wellbore 12 at the lower end of tubing string 28 is an upper completion assembly 90 that includes various tools such as a packer 92, an expansion joint 94, a packer 96, a fluid flow control module 98 and an anchor assembly 97.

Extending uphole from upper completion assembly 90 are one or more communication cables 99, such as a sensor cable or an electric cable, which passes through packers 92, 96 and extends to the surface 16 in annulus 34. Cable 99 may operate as communication media, to transmit power, or data and the like between a surface controller (not pictured) and the upper and lower completion assemblies 90, 68.

Shown deployed in association with drilling and production system 10 is computer system 500 illustrated in FIG. 5 adapted for implementing a CBM program based on life-stress acceleration models as described herein. For example, during a completion procedure, the environment in lower completion assembly 68 and upper completion assembly 90 is operated, and additionally or alternatively, the actual condition of lower completion assembly 68 and/or upper completion assembly 90 may be monitored and utilized by computer system 500 as described above to determine a maintenance program for lower completion assembly 68 and/or upper completion assembly 90 or any part thereof. In this regard, the CBM program may be implemented with respect to an entire system, such as lower completion assembly 68 and/or upper completion assembly 90, or individual components or tools that comprise the system, such as a packer, sand control screen assembly, fluid control module, anchor assembly or the like. Thus, a lower completion assembly 68 and/or upper completion assembly 90 may be deployed and utilized in wellbore 12 for production operations. The conditions under which these systems are operated are measured. Prior to re-deploying lower completion assembly 68 and/or upper completion assembly 90, the CBM program may be utilized to determine whether it is necessary to subject lower completion assembly 68 and/or upper completion assembly 90 to maintenance prior to additional deployments.

Advantages of the present disclosure include, but are not limited to, avoiding time-consuming and expensive lab tests, minimum changes to current maintenance systems, allowing maintenance to be performed based on condition of a tool (component), meeting customers' needs for having condition based maintenance system, and allowing interaction terms between individual stress variables to be included in a damage model.

Thus, a computer-implemented method for performing condition based maintenance (CBM) of an operating tool has been described and may generally include: determining a plurality of model parameters corresponding to stress variables associated with the tool; determining, for each step in a series of steps of an operational run of the tool, a life measure based on the plurality of model parameters and measured values of the corresponding stress variables for that step in the series of steps; calculating one or more failure parameters related to operation of the tool during the operational run based on the life measure determined for each step in the series of steps, a time duration of each step, and a life duration of the tool at reference levels of the stress variables; and performing maintenance of the tool based on the one or more failure parameters. Further, a computer-readable storage medium with instructions stored therein has been described, instructions when executed by a computer cause the computer to perform a plurality of functions, including functions to: determine a plurality of model parameters corresponding to stress variables associated with the tool; determine, for each step in a series of steps of an operational run of the tool, a life measure based on the plurality of model parameters and measured values of the corresponding stress variables for that step in the series of steps; calculate one or more failure parameters related to operation of the tool during the operational run based on the life measure determined for each step in the series of steps, a time duration of each step, and a life duration of the tool at reference levels of the stress variables; and generate a maintenance order for performing maintenance of the tool based on the one or more failure parameters.

For the foregoing embodiments, the method or functions may include any one of the following steps, alone or in combination with each other: Determining the plurality of model parameters comprises determining the plurality of model parameters based on data associated with failure times of the tool, suspension times of the tool, and levels of the stress variables throughout an operational life of the tool; Determining the plurality of model parameters comprises determining values that maximize a log likelihood function of a probability density function (PDF) of a failure distribution, wherein the failure distribution is computed based on levels of the stress variables within each step in the series of steps; Determining the plurality of model parameters comprises estimating the plurality of model parameters based on at least one of domain knowledge of the tool, comparison with one or more other tools, or manufacturer's data associated with the tool; Determining the plurality of model parameters comprises adjusting the plurality of model parameters based on the one or more failure parameters, and failure rates of the tool; Determine values of the plurality of model parameters that maximize a log likelihood function of a probability density function (PDF) of a failure distribution, and wherein the failure distribution is computed based on levels of the stress variables varying for each step in the series of steps;

One or more failure parameters comprise a failure distribution during a step in the series of steps, and the failure distribution is computed based on the life measure associated with the step in accordance with the combined Weibull General Log Linear (GLL) model; The life measure for each step in the series of steps of the operational run of the tool is determined using the General Log Linear (GLL) model comprising the plurality of model parameters and the measured values of the corresponding stress variables for that step; One or more failure parameters comprise a remaining useful life (RUL) parameter associated with the tool, and the RUL parameter is calculated based on the life duration of the tool at the reference levels of the stress variables and a proportion of life of the tool consumed over the operational run; The proportion of life of the tool consumed over the operational run is computed by summing, for all steps in the series of steps of the operational run, ratios of the time duration and the life measure for each step in the series of steps; One or more failure parameters comprise equivalent hours computed as a product of the life duration of the tool at the reference levels of the stress variables and the proportion of life of the tool consumed over the operational run.

Likewise, a system for performing condition based maintenance of an operating tool has been described and includes at least one processor and a memory coupled to the processor having instructions stored therein, which when executed by the processor, cause the processor to perform functions, including functions to: obtain, from the memory, a plurality of model parameters corresponding to stress variables associated with the tool; determine, for each step in a series of steps of an operational run of the tool, a life measure based on the plurality of model parameters and measured values of the corresponding stress variables for that step in the series of steps; calculate one or more failure parameters related to operation of the tool during the operational run based on the life measure determined for each step in the series of steps, a time duration of each step, and a life duration of the tool at reference levels of the stress variables; and generate a maintenance order for performing maintenance of the tool based on the one or more failure parameters.

For any of the foregoing embodiments, the system may include any one of the following elements, alone or in combination with each other: the functions performed by the processor include functions to obtain, from the memory, the plurality of model parameters determined based on data associated with failure times of the tool, suspension times of the tool, and levels of the stress variables throughout an operational life of the tool; the functions performed by the processor include functions to obtain, from the memory, the plurality of model parameters determined as values that maximize a log likelihood function of a probability density function (PDF) of a failure distribution, and wherein the failure distribution is computed based on levels of the stress variables within each step in the series of steps; the functions performed by the processor include functions to obtain, from the memory, the plurality of model parameters estimated based on at least one of domain knowledge of the tool, comparison with one or more other tools, or manufacturer's data associated with the tool; the functions performed by the processor include functions to adjust the plurality of model parameters based on the one or more failure parameters, and failure rates of the tool.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

While specific details about the above embodiments have been described, the above hardware and software descriptions are intended merely as example embodiments and are not intended to limit the structure or implementation of the disclosed embodiments. For instance, although many other internal components of computer system 500 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

What is claimed is:

1. A computer-implemented method for performing condition based maintenance of an operating tool, the method comprising:
determining a plurality of model parameters corresponding to stress variables associated with the tool;
determining, for each step in a series of steps of an operational run of the tool, a life measure based on the plurality of model parameters and measured values of the corresponding stress variables for that step in the series of steps;
calculating one or more failure parameters related to operation of the tool during the operational run based on the life measure determined for each step in the series of steps, a time duration of each step, and a life duration of the tool at reference levels of the stress variables; and
performing maintenance of the tool based on the one or more failure parameters.

2. The method of claim 1, wherein determining the plurality of model parameters comprises:
determining the plurality of model parameters based on data associated with failure times of the tool, suspension times of the tool, and levels of the stress variables throughout an operational life of the tool.

3. The method of claim 1, wherein determining the plurality of model parameters comprises:
determining values that maximize a log likelihood function of a probability density function (PDF) of a failure distribution, and wherein the failure distribution is computed based on levels of the stress variables within each step in the series of steps.

4. The method of claim 1, wherein determining the plurality of model parameters comprises:
estimating the plurality of model parameters based on at least one of domain knowledge of the tool, comparison with one or more other tools, or manufacturer's data associated with the tool.

5. The method of claim 1, further comprising:
adjusting the plurality of model parameters based on the one or more failure parameters, and failure rates of the tool.

6. The method of claim 1, wherein:
the one or more failure parameters comprise a failure distribution during a step in the series of steps; and
the failure distribution is computed based on the life measure associated with the step in accordance with the combined Weibull General Log Linear (GLL) model.

7. The method of claim 1, wherein the life measure for each step in the series of steps of the operational run of the tool is determined using the General Log Linear (GLL) model comprising the plurality of model parameters and the measured values of the corresponding stress variables for that step.

8. The method of claim 1, wherein:
the one or more failure parameters comprise a remaining useful life (RUL) parameter associated with the tool; and
the RUL parameter is calculated based on the life duration of the tool at the reference levels of the stress variables and a proportion of life of the tool consumed over the operational run.

9. The method of claim 8, wherein:
the proportion of life of the tool consumed over the operational run is computed by summing, for all steps in the series of steps of the operational run, ratios of the time duration and the life measure for each step in the series of steps.

10. The method of claim 9, wherein the one or more failure parameters further comprise equivalent hours computed as a product of the life duration of the tool at the reference levels of the stress variables and the proportion of life of the tool consumed over the operational run.

11. A system for performing condition based maintenance of an operating tool, the system comprising:
at least one processor; and
a memory coupled to the processor having instructions stored therein, which when executed by the processor, cause the processor to perform functions, including functions to:
obtain, from the memory, a plurality of model parameters corresponding to stress variables associated with the tool;
determine, for each step in a series of steps of an operational run of the tool, a life measure based on the plurality of model parameters and measured values of the corresponding stress variables for that step in the series of steps;
calculate one or more failure parameters related to operation of the tool during the operational run based on the life measure determined for each step in the series of steps, a time duration of each step, and a life duration of the tool at reference levels of the stress variables; and
generate a maintenance order for performing maintenance of the tool based on the one or more failure parameters.

12. The system of claim 11, wherein the functions performed by the processor include functions to:
obtain, from the memory, the plurality of model parameters determined based on data associated with failure times of the tool, suspension times of the tool, and levels of the stress variables throughout an operational life of the tool.

13. The system of claim 11, wherein the functions performed by the processor include functions to:
obtain, from the memory, the plurality of model parameters determined as values that maximize a log likelihood function of a probability density function (PDF) of a failure distribution, and wherein the failure distribution is computed based on levels of the stress variables within each step in the series of steps.

14. The system of claim 11, wherein the functions performed by the processor include functions to:
obtain, from the memory, the plurality of model parameters estimated based on at least one of domain knowledge of the tool, comparison with one or more other tools, or manufacturer's data associated with the tool.

15. The system of claim 11, wherein the functions performed by the processor include functions to:
adjust the plurality of model parameters based on the one or more failure parameters, and failure rates of the tool.

16. The system of claim 11, wherein:
the one or more failure parameters comprise a failure distribution during a step in the series of steps; and
the failure distribution is computed based on the life measure associated with the step in accordance with the combined Weibull General Log Linear (GLL) model.

17. The system of claim 11, wherein the life measure for each step in the series of steps of the operational run of the tool is determined using the General Log Linear (GLL) model comprising the plurality of model parameters and the measured values of the corresponding stress variables for that step.

18. The system of claim 11, wherein:
the one or more failure parameters comprise a remaining useful life (RUL) parameter associated with the tool; and
the RUL parameter is calculated based on the life duration of the tool at the reference levels of the stress variables and a proportion of life of the tool consumed over the operational run.

19. The system of claim 18, wherein:
the proportion of life of the tool consumed over the operational run is computed by summing, for all steps in the series of steps of the operational run, ratios of the time duration and the life measure for each step in the series of steps.

20. The system of claim 19, wherein the one or more failure parameters further comprise equivalent hours computed as a product of the life duration of the tool at the reference levels of the stress variables and the proportion of life of the tool consumed over the operational run

21. A computer-readable storage medium having instructions stored therein, which when executed by a computer cause the computer to perform a plurality of functions, including functions to:
determine a plurality of model parameters corresponding to stress variables associated with the tool;
determine, for each step in a series of steps of an operational run of the tool, a life measure based on the plurality of model parameters and measured values of the corresponding stress variables for that step in the series of steps;
calculate one or more failure parameters related to operation of the tool during the operational run based on the life measure determined for each step in the series of steps, a time duration of each step, and a life duration of the tool at reference levels of the stress variables; and
generate a maintenance order for performing maintenance of the tool based on the one or more failure parameters.

22. The computer-readable storage medium of claim 21, wherein the instructions further perform functions to:
determine values that maximize a log likelihood function of a probability density function (PDF) of a failure distribution, and wherein the failure distribution is computed based on levels of the stress variables varying for each step in the series of steps.
